(19) United States
(12) Patent Application Publication
(10) Pub. No.: US 2026/0281586 A1
(43) Pub. Date: Sep. 17, 2026

(54) IMAGE CAPTURING APPARATUSES, PROCESSING METHODS FOR IMAGE CAPTURING APPARATUSES, AND STORAGE MEDIUMS

(71) Applicant: CANON KABUSHIKI KAISHA, Tokyo (JP)

(72) Inventor: AKITOMO SASAKI, Kanagawa (JP)

(21) Appl. No.: 19/560,739

(22) Filed: Mar. 9, 2026

(30) Foreign Application Priority Data
Mar. 14, 2025 (JP) 2025-041377

(51) Int. Cl. H04N 25/76; H04N 23/617; H04N 23/90

(52) U.S. Cl. CPC H04N 25/7795; H04N 23/617; H04N 23/90

(57) ABSTRACT

One or more apparatuses, methods, and storage mediums are provided herein. An image capturing apparatus may include one or more processors that operate to acquire a first timecode generated based on a current time and set the first timecode to a counter; for a predetermined time period or a predetermined number of times, acquire the first timecode which has been generated based on a current time, acquire a second timecode counted by the counter based on the set first timecode, and repeatedly perform processing to compare the first timecode and the second timecode; and add the second timecode counted by the counter to each frame of a captured image, wherein the one or more processors acquire the first timecode generated based on a current time and set the first timecode to the counter according to a result of the comparison performed by the one or more processors.

This application claims priority to, and the benefit of, Japanese Patent Application No. 2025-041377, filed March 14, 2025, which is hereby incorporated by reference herein in its entirety.

### BACKGROUND

### Field of the Technology

The present disclosure relates to one or more embodiments of image capturing apparatuses, processing methods for the image capturing apparatuses, and storage mediums.

### Description of the Related Art

A timecode may be recorded together with a captured image to identify a time point of the captured image captured by an image capturing apparatus. A timecode includes time (hour, minute, second) and a frame number (for example, 0 to 24 in the case of 25 frames per second).

When a plurality of image capturing apparatuses is used for image capturing, synchronizing timecodes of moving images captured by the respective image capturing apparatuses facilitates subsequent editing operations. Thus, it is desirable that the timecodes held by the respective image capturing apparatuses be synchronized.

Japanese Patent Laid-Open No. 2015-23521 describes a recording apparatus including a recording unit for adding a timecode to each frame of a plurality of frames of moving image signals and storing the plurality of frames, and a control unit for receiving standard time information and correcting the timecode based on the received standard time information. The control unit corrects the timecode in a case where the received standard time information indicates a predetermined time.

A timecode that is held by an image capturing apparatus and added to a captured image frame will be referred to as an image capturing timecode.

An example of a method for synchronizing timecodes held by a plurality of image capturing apparatuses is synchronizing clocks of the image capturing apparatuses, generating a timecode from the synchronized clocks, and setting the timecode to the image capturing apparatuses. By setting the timecode generated from the synchronized clocks as an image capturing timecode, timecodes held by the respective plurality of image capturing apparatuses can be synchronized. Since identical timecodes are generated from the same time, synchronization of timecodes can be achieved regardless of when the setting is performed.

However, in this case, if the plurality of image capturing apparatuses starts image capturing without synchronizing frame image capturing start time points, frame image capturing start times of the respective image capturing apparatuses become different from each other. For example, a first image capturing apparatus may start image capturing at a time point of 14:47:23.70, whereas a second image capturing apparatus may start image capturing at a time point of 14:47:23.71. In a case where the moving image frame rate is 25 frames per second, the time interval between frames is 0.04 seconds. Thus, images captured by the two image capturing apparatuses at the respective time points can be considered to correspond to substantially the same time.

As described above, if frame image capturing start time points of the respective image capturing apparatuses are not synchronized with each other, even if a timecode generated from the time at which the image capturing apparatuses have been synchronized is set to the image capturing apparatuses, the image capturing timecodes of the respective image capturing apparatuses may be offset by nearly one frame depending on the timing of the setting.

### SUMMARY

According to one or more aspects of the present disclosure, one or more embodiments of an image capturing apparatus includes one or more processors that operate to acquire a first timecode generated based on a current time and set the first timecode to a counter; for a predetermined time period or a predetermined number of times, acquire the first timecode which has been generated based on a current time, acquire a second timecode counted by the counter based on the set first timecode, and repeatedly perform processing to compare the first timecode and the second timecode; and add the second timecode counted by the counter to each frame of a captured image, wherein the one or more processors acquire the first timecode generated based on a current time and set the first timecode to the counter according to a result of the comparison performed by the one or more processors.

According to other aspects of the present disclosure, one or more additional image capturing apparatuses, one or more processing methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of at least one embodiment of a configuration of an image capturing apparatus according to one or more aspects of the present disclosure.

FIG. 2 is a diagram illustrating at least one embodiment of a configuration example of an image capturing system according to one or more aspects of the present disclosure.

FIG. 3 is a flowchart of at least one embodiment of a procedure for setting a reference timecode to an image capturing timecode counter according to one or more aspects of the present disclosure.

FIG. 4 is a diagram illustrating one or more embodiments of examples of a synchronized time, a reference timecode, and a setting of the reference timecode to image capturing apparatuses according to one or more aspects of the present disclosure.

FIG. 5 is a diagram illustrating one or more embodiments of examples of a synchronized time, a reference timecode, and a setting of the reference timecode to the image capturing apparatuses according to one or more aspects of the present disclosure.

FIG. 6A and FIG. 6B are diagrams illustrating at least one embodiment of a comparison between a reference timecode and an image capturing timecode after a reference timecode has been set according to one or more aspects of the present disclosure.

FIG. 7 is a flowchart of at least one embodiment of a procedure for setting a reference timecode to the image capturing apparatus according to one or more aspects of the present disclosure.

FIG. 8 is a flowchart of at least one embodiment of a procedure for setting a reference timecode to the image capturing apparatus according to one or more aspects of the present disclosure.

FIG. 9 is a diagram illustrating at least one embodiment of a timing for setting a reference timecode again after comparing a reference timecode and an image capturing timecode according to one or more aspects of the present disclosure.

### DESCRIPTION OF THE EMBODIMENTS

### One or More Embodiments

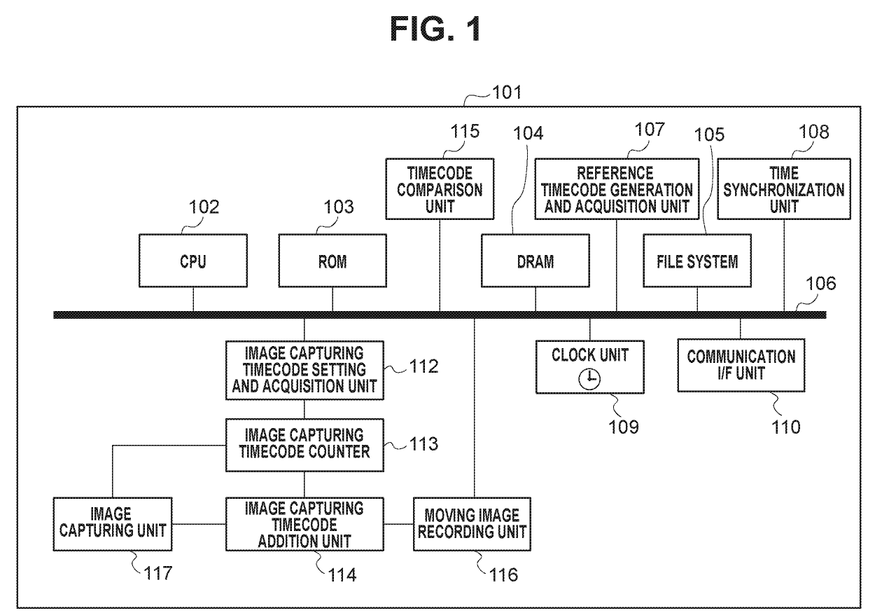

FIG. 1 illustrates an example of at least one embodiment of a configuration of an image capturing apparatus 101 according to one or more aspects of the present disclosure. The image capturing apparatus 101 includes a central processing unit (CPU) 102, a read-only memory (ROM) 103, a dynamic random-access memory (DRAM) 104, a file system 105, a bus 106, a reference timecode generation and acquisition unit 107, a time synchronization unit 108, a clock unit 109, and a communication interface (I/F) unit 110. In addition, the image capturing apparatus 101 includes an image capturing timecode setting and acquisition unit 112, an image capturing timecode counter 113, an image capturing timecode addition unit 114, a timecode comparison unit 115, a moving image recording unit 116, and an image capturing unit 117.

The communication I/F unit 110 is a media access control (MAC) that controls Ethernet.

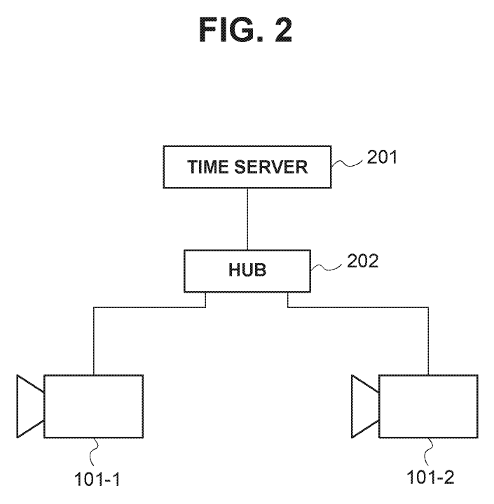

The time synchronization unit 108 communicates with a time server 201 externally provided as illustrated in FIG. 2 via a network and synchronizes the time of the clock unit 109 with the time server 201 externally provided.

The reference timecode generation and acquisition unit 107 reads the time from the clock unit 109 and generates a timecode based on the time. The timecode is a code to be added, when a moving image is recorded, to each image of the recorded moving image in order to identify each image (each frame). The timecode generally includes hour, minute, second, and frame number.

The image capturing timecode counter 113 holds the timecode to be added to each frame of the captured moving image. Each time the image capturing unit 117 captures one frame in response to an image capturing timing signal, the image capturing timecode counter 113 increments by one.

The image capturing timecode counter 113 is connected to the image capturing unit 117 and receives a frame image capturing timing signal from the image capturing unit 117.

The image capturing timecode addition unit 114 adds the value of the image capturing timecode counter 113 to an image captured by the image capturing unit 117.

The moving image recording unit 116 records the captured image data to which an image capturing timecode has been added.

The image capturing timecode setting and acquisition unit 112 sets an arbitrary value to the image capturing timecode counter 113. Further, the image capturing timecode setting and acquisition unit 112 acquires the value of the image capturing timecode counter 113.

A program that is executed by the CPU 102 may acquire the current value of the image capturing timecode counter 113 from the image capturing timecode setting and acquisition unit 112. The image capturing timecode counter 113 after the image capturing timecode has been changed increments by one in response to receipt of the next frame image capturing timing signal from the image capturing unit 117.

The timecode comparison unit 115 compares an image capturing timecode acquired from the image capturing timecode setting and acquisition unit 112 with a reference timecode acquired from the reference timecode generation and acquisition unit 107.

FIG. 2 is a diagram illustrating at least one embodiment of an example configuration of an image capturing system. The image capturing system includes a first image capturing apparatus 101-1, a second image capturing apparatus 101-2, the time server 201, and a hub 202. The first image capturing apparatus 101-1 and the second image capturing apparatus 101-2 each correspond to the image capturing apparatus 101 illustrated in FIG. 1.

FIG. 2 illustrates an example in which the two image capturing apparatuses 101 and the time server 201 are connected to each other via a network through the hub 202. The time server 201 provides its time. The first image capturing apparatus 101-1 and the second image capturing apparatus 101-2 communicate with the time server 201 to synchronize the respective times of the individual clock units 109 with the time of the time server 201. The hub 202 is used to connect the time server 201, the first image capturing apparatus 101-1, and the second image capturing apparatus 101-2 via the network.

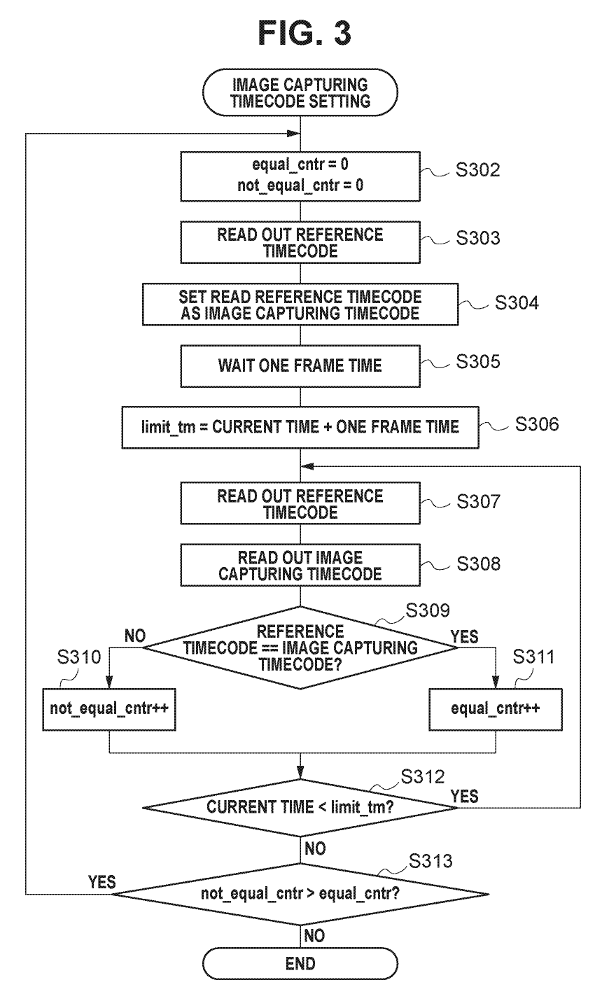

FIG. 3 is a flowchart of at least one embodiment of a procedure for setting a reference timecode as an image capturing timecode of the image capturing apparatus 101.

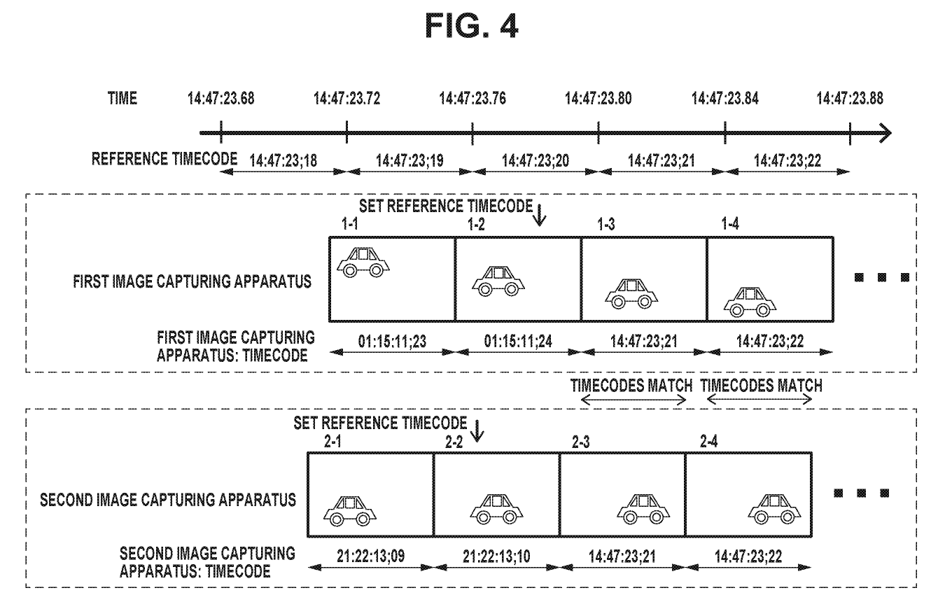

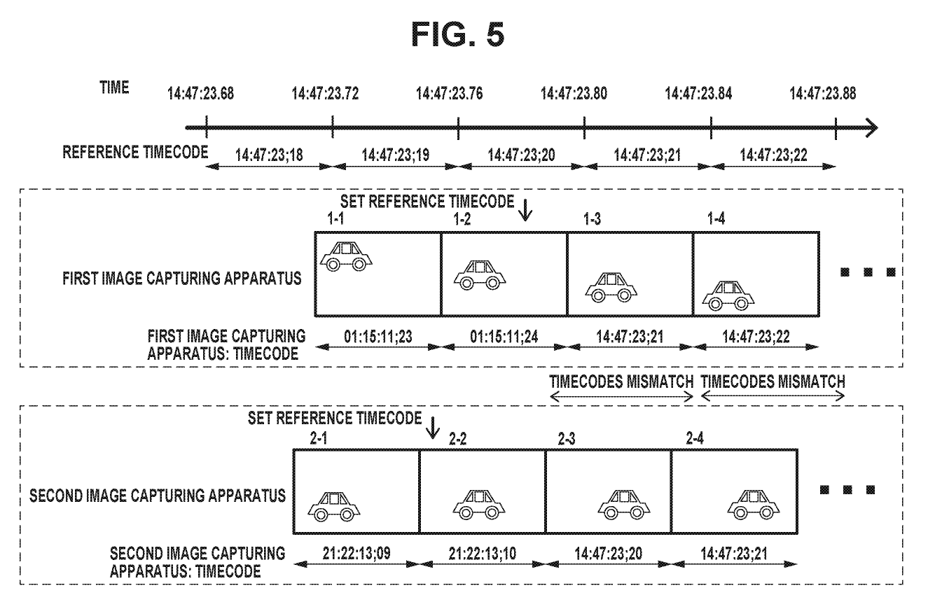

FIGS. 4 and 5 are diagrams each illustrating one or more embodiments of time serving as a generation source of a reference timecode, reference timecodes, image capturing timecodes of the first image capturing apparatus 101-1, and image capturing timecodes of the second image capturing apparatus 101-2. The time of the clock unit 109 of the first image capturing apparatus 101-1 and the time of the clock unit 109 of the second image capturing apparatus 101-2 are synchronized with the time server 201, and the clock units 109 maintain the same time. Thus, in both FIGS. 4 and 5, individual times are omitted, and the common time is illustrated. Because power supplies of the respective image capturing apparatuses 101 are turned on at different timings, frame start time points differ between the image capturing apparatuses 101. In addition, because a setting of a reference timecode to each of the image capturing timecode counters 113 is performed via a menu or the like on a display panel of the respective image capturing apparatuses 101, the setting timings of the reference timecode also differ between the image capturing apparatuses 101. The timing for setting a reference timecode to the second image capturing apparatus 101-2 differs between the cases illustrated in FIGS. 4 and 5.

First, the setting of a reference timecode will be described with reference to FIGS. 1, 4, and 5. In one or more embodiments, a moving image is captured at 25 frames per second. A reference timecode generated when the time is 14:47:23.68 is 14:47:23;18. A reference timecode generated when the time is 14:47:23.72 is 14:47:23;19.

The detailed method for acquiring a timecode from a time is described in Society of Motion Picture and Television Engineers (SMPTE) Standard 2059-1 (ST-2059-1).

In FIG. 1, the CPU 102 of the image capturing apparatus 101 acquires a reference timecode from the reference timecode generation and acquisition unit 107 and sets the reference timecode to the image capturing apparatus 101 using the image capturing timecode setting and acquisition unit 112. The setting of an image capturing timecode is performed by software. Therefore, it is not possible to control the setting of an image capturing timecode in synchronization with a frame start timing, and the time point before the next frame at which an image capturing timecode will be set is not fixed.

Since frame start time points differ between the image capturing apparatuses 101, and the timings for setting a timecode cannot be controlled, there may be a case in which image capturing timecodes of the plurality of image capturing apparatuses 101 cannot be considered to match each other. This will be described below.

First, the following describes a case in which image capturing timecodes of the plurality of image capturing apparatuses 101 may be considered to match each other. FIG. 4 illustrates a case in which each of the first image capturing apparatus 101-1 and the second image capturing apparatus 101-2 sets a reference timecode (14:47:23;20) as an image capturing timecode at timings indicated by arrows labeled "SET REFERENCE TIMECODE" in FIG. 4. A timecode of a frame 1-3 of the first image capturing apparatus 101-1 after the reference timecode has been set becomes 14:47:23;21, and a timecode of a frame 2-3 of the second image capturing apparatus 101-2 becomes 14:47:23;21. Similarly, a timecode of a frame 1-4 of the first image capturing apparatus 101-1 becomes 14:47:23;22, and a timecode of a frame 2-4 of the second image capturing apparatus 101-2 becomes 14:47:23;22. As indicated by double arrows labeled "TIMECODES MATCH" in FIG. 4, a time period during which the image capturing timecodes match each other is long. In this case, the timecodes may be considered to match each other.

On the other hand, FIG. 5 illustrates a case in which the second image capturing apparatus 101-2 sets a reference timecode as an image capturing timecode at a timing indicated by an arrow labeled "SET REFERENCE TIMECODE". A timecode of a frame 1-3 of the first image capturing apparatus 101-1 after the reference timecode has been set becomes 14:47:23;21. A timecode of a frame 2-3 of the second image capturing apparatus 101-2 becomes 14:47:23;20. As indicated by double arrows labeled "TIMECODES MISMATCH" in FIG. 5, a time period during which the image capturing timecodes do not match each other is long, and the timecodes may be considered to be mismatched.

In one or more embodiments, the timecode comparison unit 115 is provided to compare an image capturing timecode and a reference timecode, and in a case where the timecode comparison unit 115 determines that a time period during which the timecodes match each other is short, timecode resetting is performed.

The following is a description of one or more embodiments with reference to FIGS. 1, 2, 3, 6A, and 6B.

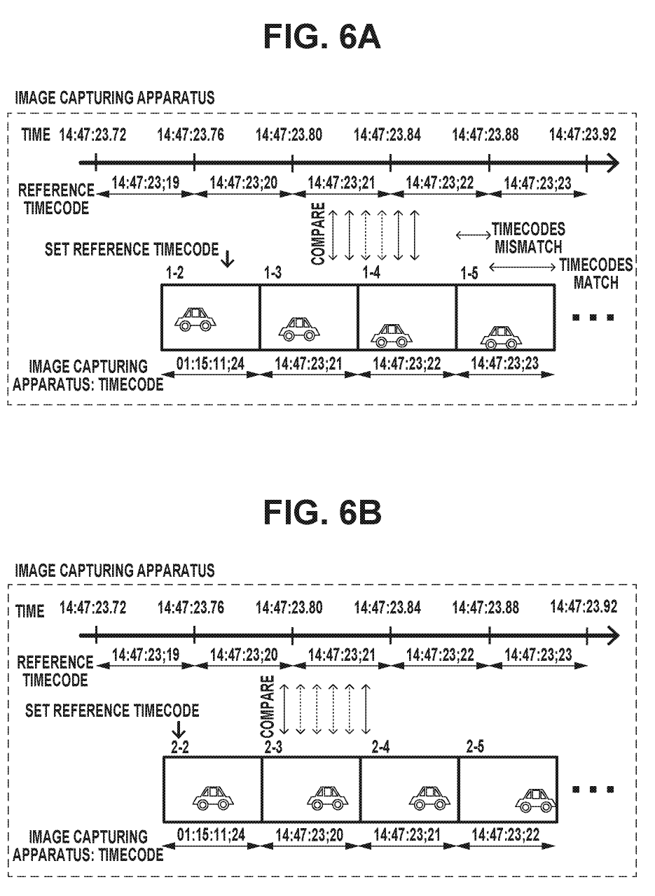

FIG. 3 is a flowchart of at least one embodiment of a procedure according to one or more aspects of the present disclosure. FIGS. 6A and 6B are diagrams similar to FIGS. 4 and 5. FIG. 6A is an example in which a time period during which an image capturing timecode and a reference timecode match each other is long, and FIG. 6B is an example in which a time period during which an image capturing timecode and a reference timecode match each other is short. A processing method of the image capturing apparatus 101 will be described.

In step S302 of the flowchart illustrated in FIG. 3, the CPU 102 sets both equal_cntr and not_equal_cntr to 0. Equal_cntr is a counter for counting the number of times a reference timecode and an image capturing timecode match each other. Not_equal_cntr is a counter for counting the number of times a reference timecode and an image capturing timecode do not match each other.

In step S303, the CPU 102 reads out a reference timecode using the reference timecode generation and acquisition unit 107.

In step S304, the CPU 102 sets the reference timecode read out in step S303 to the image capturing timecode counter 113 using the image capturing timecode setting and acquisition unit 112.

In step S305, since the set image capturing timecode is reflected in the next frame as a value incremented by one, the CPU 102 waits for a time period of one frame. For example, when a moving image is captured at 25 frames per second, the CPU 102 waits for 40 milliseconds.

In step S306, the CPU 102 calculates a time period for performing a comparison. The CPU 102 acquires the current time from the clock unit 109 of the image capturing apparatus 101, adds a duration of one frame to the acquired time, and assigns the result to limit_tm. The CPU 102 repeatedly compares a reference timecode and an image capturing timecode until the current time reaches limit_tm. In the examples illustrated in FIGS. 6A and 6B, the comparison is performed six times within one frame time period.

In steps S307 to S312, the CPU 102 repeatedly performs the comparison processing between a reference timecode and an image capturing timecode.

In step S307, the CPU 102 reads out a reference timecode from the reference timecode generation and acquisition unit 107.

In step S308, the CPU 102 reads out an image capturing timecode from the image capturing timecode setting and acquisition unit 112.

In step S309, the CPU 102 compares a value of the reference timecode with a value of the image capturing timecode. In a case where the reference timecode and the image capturing timecode do not have the same value (NO in step S309), the processing proceeds to step S310. In a case where the reference timecode and the image capturing timecode have the same value (YES in step S309), the processing proceeds to step S311.

In step S310, the CPU 102 increments a value of not_equal_cntr by one, and the processing proceeds to step S312.

In step S311, the CPU 102 increments a value of equal_cntr by one, and the processing proceeds to step S312.

In step S312, the CPU 102 determines whether the current time of the clock unit 109 is less than limit_tm. In a case where the CPU 102 determines that the current time is less than limit_tm (YES in step S312), the comparison for one frame time period has not yet been completed, and thus, the processing returns to step S307.

In a case where the CPU 102 determines that the current time is more than or equal to limit_tm (NO in step S312), the processing proceeds to step S313.

In step S313, the CPU 102 compares the value of not_equal_cntr and the value of equal_cntr. In a case where the value of not_equal_cntr is more than the value of equal_cntr (YES in step S313), the CPU 102 determines that the time period during which a reference timecode and an image capturing timecode match each other is short, and the processing returns to step S302 to perform the timecode setting processing again. In a case where the value of not_equal_cntr is less than or equal to the value of equal_cntr (NO in step S313), the CPU 102 determines that the time period during which a reference timecode and an image capturing timecode match each other is long, and thus the image capturing timecode setting processing ends.

With the configuration(s) described above, image capturing timecodes of the plurality of image capturing apparatuses 101 may be synchronized with each other. This facilitates editing of a plurality of moving images captured by the plurality of image capturing apparatuses 101 by using moving image editing software on a PC or the like.

In the examples illustrated in FIGS. 6A and 6B, the comparison timings are indicated by vertical arrows. A solid arrow indicates a point at which a reference timecode and an image capturing timecode match each other, and a dotted line arrow indicates a point at which a reference timecode and an image capturing timecode do not match each other, as a result of the comparison. In the example illustrated in FIG. 6A, among six comparisons, a reference timecode and an image capturing timecode match each other in four comparisons and do not match each other in two comparisons, so that the CPU 102 may determine that the time period during which a reference timecode and an image capturing timecode match each other is long. In the example illustrated in FIG. 6B, among the comparisons, a reference timecode and an image capturing timecode match each other in two comparisons and do not match each other in four comparisons, so that the CPU 102 may determine that the time period during which a reference timecode and an image capturing timecode do not match each other is long.

As described above, by measuring a reference timecode and an image capturing timecode multiple times and counting the numbers of times a reference timecode and an image capturing timecode match and do not match each other, the time period during which the timecodes match and the time period during which the timecodes do not match each other may be compared. Each time when the time period during which the timecodes do not match each other is long, a reference timecode is set again to the image capturing timecode counter 113, so that the setting is performed in such a manner that the time period during which a reference timecode and an image capturing timecode match each other becomes long.

In one or more embodiments, although the comparison between a reference timecode and an image capturing timecode is performed for one frame time period, the comparison may also be performed for multiple frames. This may be achieved by adding a duration corresponding to the multiple frames (an integer multiple of the duration for one frame) to the current time in the calculation for obtaining limit_tm in step S306 illustrated in FIG. 3. Performing the comparison for the multiple frames reduces an influence of, for example, a case in which the comparison cannot be executed at regular intervals.

### One or More Additional Embodiments

In the aforementioned one or more embodiments, although the comparison between a reference timecode and an image capturing timecode is performed for one frame time period, the comparison may be performed based on the number of comparisons.

In a case where the number of the comparisons is increased, and the time to be taken for the comparisons takes several frames or more, even if or in a case where the comparison is stopped in the middle of a frame, the influence may be minimized. For example, in a case where timecodes are repeatedly acquired and compared, and the process takes a time period of 100.5 frames (100 frames + 0.5 frames), the influence of the 0.5 frames is about 0.5%. Further, increasing the number of the comparisons reduces the influence of fluctuations caused by software execution in the comparisons of timecodes.

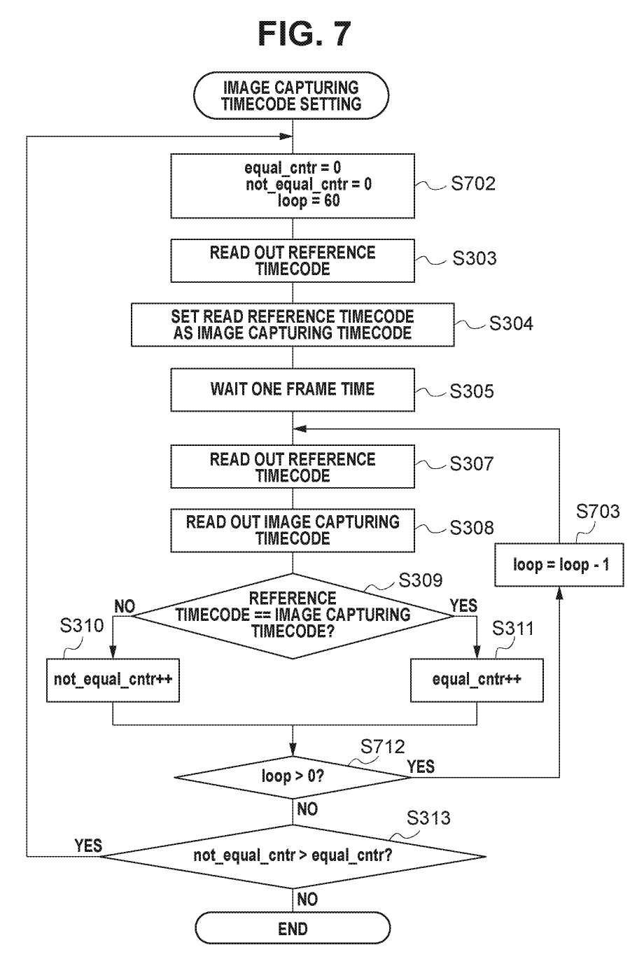

The following is a description of one or more additional embodiments with reference to FIG. 7. FIG. 7 is a flowchart without step S306 in the flowchart illustrated in FIG. 3, with steps S702 and S712 instead of steps S302 and S312, and additionally including step S703. The differences between the flowcharts illustrated in FIG. 7 and FIG. 3 will be described.

In step S702, in addition to initializing the variables in step S302, the CPU 102 initializes a variable loop to 60, which specifies the number of repetitions. Then, the processing proceeds to step S303.

Step S712 is provided in place of step S312 of the flowchart illustrated in FIG. 3. In step S712, the CPU 102 determines whether a value of loop is more than 0. In a case where the CPU 102 determines that the value of loop is more than 0 (YES in step S712), the processing proceeds to step S703. In a case where the value of loop is 0 (NO in step S712), the processing proceeds to step S313.

In step S703, the CPU 102 decrements the value of loop by one, and the processing returns to step S307.

With the configuration(s) as described above, even in a case where the processing is performed based on the number of comparisons, the comparison between the reference timecode and the image capturing timecode may be performed.

Although in step S313 of the flowchart illustrated in FIG. 3 of the aforementioned one or more embodiments and step S313 of the flowchart illustrated in FIG. 7 of one or more additional embodiments, the number of matches and the number of mismatches between a reference timecode and an image capturing timecode are compared, a threshold for determining synchronization between a reference timecode and an image capturing timecode may be set, and in a case where the number of matches is more than or equal to the threshold, it may be determined that timecodes are synchronized with each other, so that the processing may be ended. Alternatively, a threshold for the number of mismatches may be set, and in a case where the number of mismatches is more than or equal to the threshold, a reference timecode may be set again to the image capturing timecode counter 113.

### One or More Further Embodiments

Next, a method for setting a reference timecode as an image capturing timecode again in the aforementioned one or more embodiments will be described with reference to FIGS. 1, 2, 8, and 9.

In the aforementioned one or more embodiments or one or more additional embodiments, in a case where the time period during which a reference timecode and an image capturing timecode match each other becomes short after a reference timecode has been set to the image capturing timecode counter 113, a reference timecode is set again. At this time, depending on the timing of setting a reference timecode again, there is a possibility that the time period during which a reference timecode and an image capturing timecode match each other becomes short again. In one or more further embodiments, a reference timecode is set at a timing in a case where or when the time period during which a reference timecode and an image capturing timecode match each other becomes long.

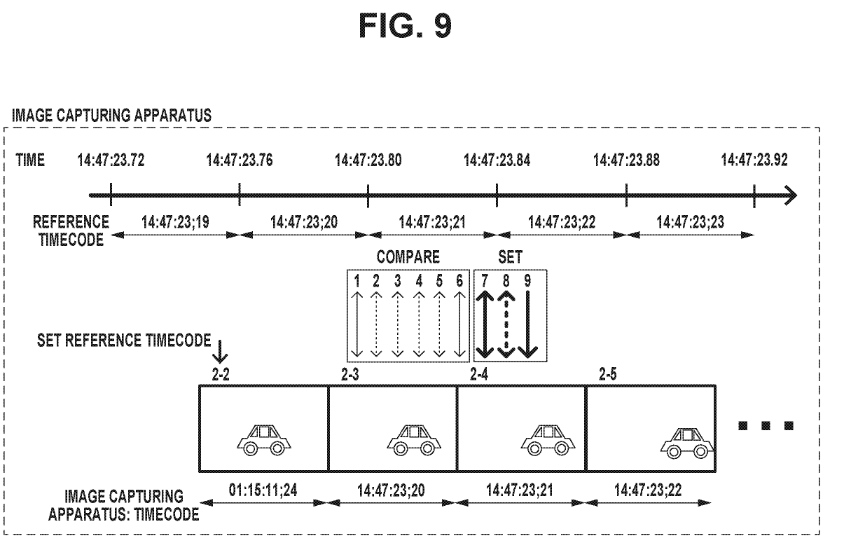

The one or more further embodiments will be described with reference to FIG. 9. FIG. 9 is a diagram, based on the diagram illustrated in FIG. 6B, additionally including a timing of setting. A process in a box labeled "COMPARE" in FIG. 9 is the process described above in the aforementioned one or more embodiments. After a determination in the process indicated by the frame labeled "COMPARE" that the time period during which timecodes match each other is short, further comparisons are continuously performed. In this processing, at a timing when or in a case where a state between a reference timecode and an image capturing timecode changes from "match" to "mismatch", the reference timecode is set to the image capturing timecode counter 113. In FIG. 9, in a seventh comparison in a box labeled "SET", a reference timecode and an image capturing timecode match each other, and in an eighth comparison, a reference timecode and an image capturing timecode do not match each other. Setting a reference timecode to the image capturing timecode counter 113 immediately after the eighth comparison allows the setting to be performed at a timing when or in a case where the time period during which timecodes match each other becomes long.

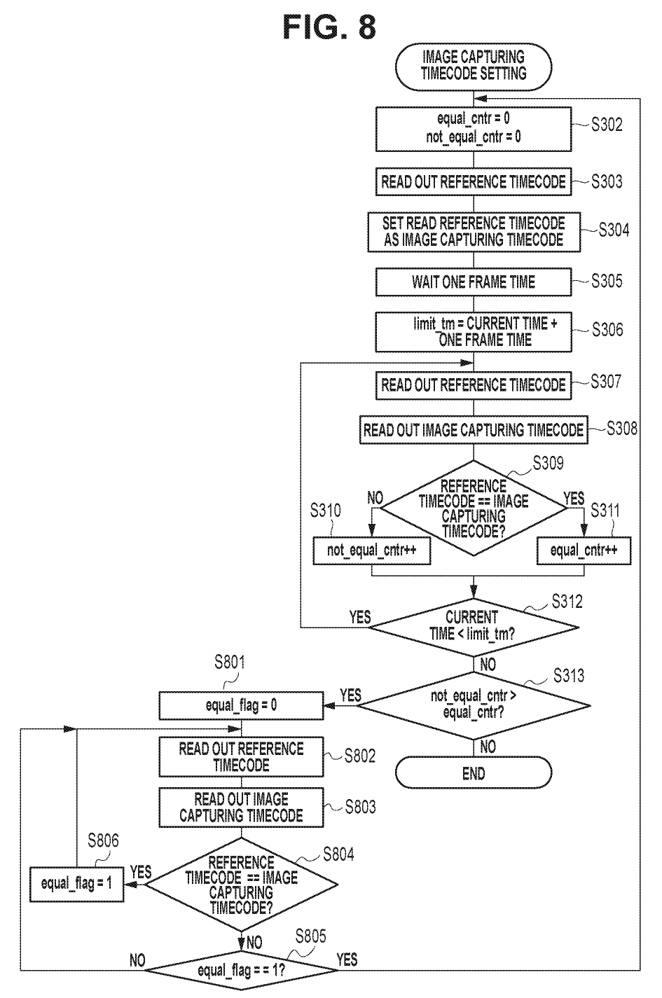

FIG. 8 illustrates a flowchart in one or more further embodiments. The flowchart illustrated in FIG. 8 is almost the same as the flowchart illustrated in FIG. 3, but processing after determination in step S313 that the time period during which timecodes match each other is short is different.

In step S313, in a case where not_equal_cntr is more than equal_cntr (YES in step S313), the processing proceeds to step S801.

In step S801, the CPU 102 assigns 0 to equal_flag that indicates whether a reference timecode and an image capturing timecode have been matched each other in the timecode comparison, to initialize equal_flag.

In step S802, the CPU 102 reads out a reference timecode.

In step S803, the CPU 102 reads out an image capturing timecode.

In step S804, the CPU 102 determines whether the reference timecode and the image capturing timecode match each other. In a case where the CPU 102 determines that the reference timecode and the image capturing timecode match each other (YES in step S804), the processing proceeds to step S806. In a case where the CPU 102 determines that the reference timecode and the image capturing timecode do not match each other (NO in step S804), the processing proceeds to step S805.

In step S806, the CPU 102 assigns 1 to equal_flag, and the processing returns to step S802.

In step S805, the CPU 102 determines whether equal_flag is 1. In a case where the CPU 102 determines that equal_flag is not 1 (equal_flag is 0) (NO in step S805), this indicates that the state between the reference timecode and the image capturing timecode remains "mismatch", and thus the processing returns to step S802. In a case where the CPU 102 determines that equal_flag is 1 (YES in step S805), this indicates that the state between the reference timecode and the image capturing timecode changes from "match" to "mismatch", and thus the processing returns to step S302 to perform the setting again.

In step S302, the CPU 102 assigns 0 to both not_equal_cntr and equal_cntr.

In step S303, the CPU 102 reads out a reference timecode.

In step S304, the CPU 102 sets the reference timecode to the image capturing timecode counter 113.

With the above-described configuration(s), the reference timecode may be set to the image capturing timecode counter 113 immediately after the state between the reference timecode and the image capturing timecode changes from "match" to "mismatch".

With the above-described configuration(s), in a case where the time period during which a reference timecode and an image capturing timecode match each other is short, a reference timecode may be set to the image capturing timecode counter 113 at a timing when or in a case where the time period during which a reference timecode and an image capturing timecode match each other becomes long.

As described in one or more of the aforementioned one or more embodiments, the one or more additional embodiments, and the one or more further embodiments, the reference timecode generation and acquisition unit 107 generates a reference timecode based on the current time of the clock unit 109. The image capturing timecode counter 113 starts incrementing an image capturing timecode based on the set reference timecode.

In steps S303 and S304, the CPU 102 reads out a reference timecode generated based on the current time of the clock unit 109 and sets the reference timecode to the image capturing timecode counter 113.

In steps S307 to S312 or S307 to S712, the CPU 102 acquires a first timecode generated based on the current time of the clock unit 109 for a predetermined time period or a predetermined number of times, acquires an image capturing timecode incremented from the set reference timecode by the image capturing timecode counter 113, and repeatedly performs the processing to compare a reference timecode and an image capturing timecode.

In steps S307 to S312 of FIG. 3, the CPU 102 repeatedly performs the above-described processing(s) for the predetermined time period. For example, the predetermined time period corresponds to an integer multiple of the time for one frame of images captured by the image capturing unit 117. In steps S307 to S712 of the flowchart illustrated in FIG. 7, the CPU 102 repeatedly performs the above-described processing(s) the predetermined number of times.

After step S313, the processing returns to step S302 or S702 based on a result of the comparison in step S309. Specifically, in a case where the number of times the reference timecode and the image capturing timecode do not match is more than the number of times the reference timecode and the image capturing timecode match (YES in step S313), the CPU 102 returns to step S302 or S702.

Then, in steps S303 and S304, the CPU 102 acquires the reference timecode generated based on the current time of the clock unit 109 and sets the reference timecode to the image capturing timecode counter 113.

Alternatively, in step S313, in a case where the number of times the reference timecode and the image capturing timecode do not match is equal to or greater than a first threshold, the CPU 102 may return the processing to step S302 or S702. Further, in a case where the number of times the reference timecode and the image capturing timecode match is less than a second threshold, the CPU 102 may return to step S302 or S702.

In the flowchart illustrated in FIG. 8, the CPU 102 acquires the first timecode generated based on a current time of the clock unit 109 at the timing when the reference timecode and the image capturing timecode change from matching to not matching, and sets the reference timecode to the image capturing timecode counter 113.

The image capturing timecode addition unit 114 adds the image capturing timecode counted by the image capturing timecode counter 113 to each image frame captured by the image capturing unit 117.

According to the aforementioned one or more embodiments, one or more additional embodiments, and one or more further embodiments, in a case where image capturing timecodes are set for a plurality of the image capturing apparatuses 101 among which image capturing timings are not matched, the synchronization accuracy of image capturing timecodes among the plurality of the image capturing apparatuses 101 may be improved.

### One or More Other Embodiments

Embodiment(s) of the present disclosure may also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An image capturing apparatus comprising:
one or more processors that operate to:
acquire a first timecode generated based on a current time and set the first timecode to a counter;
for a predetermined time period or a predetermined number of times, acquire the first timecode which has been generated based on a current time, acquire a second timecode counted by the counter based on the set first timecode, and repeatedly perform processing to compare the first timecode and the second timecode; and
add the second timecode counted by the counter to each frame of a captured image,
wherein the one or more processors acquire the first timecode generated based on a current time and set the first timecode to the counter according to a result of the comparison performed by the one or more processors.

2. The image capturing apparatus according to claim 1, wherein in a case where a number of times the first timecode and the second timecode do not match is more than a number of times the first timecode and the second timecode match, the one or more processors acquire the first timecode generated based on a current time and set the first timecode to the counter.

3. The image capturing apparatus according to claim 1, wherein in a case where a number of times the first timecode and the second timecode do not match is more than or equal to a first threshold, the one or more processors acquire the first timecode generated based on a current time and set the first timecode to the counter.

4. The image capturing apparatus according to claim 1, wherein in a case where a number of times the first timecode and the second timecode match is less than a second threshold, the one or more processors acquire the first timecode generated based on a current time and set the first timecode to the counter.

5. The image capturing apparatus according to claim 1, wherein the one or more processors repeatedly perform the processing for the predetermined time period.

6. The image capturing apparatus according to claim 5, wherein the predetermined time period is an integer multiple of a time period for one frame of the captured image.

7. The image capturing apparatus according to claim 1, wherein the one or more processors repeatedly perform the processing the predetermined number of times.

8. The image capturing apparatus according to claim 1, wherein the one or more processors acquire the first timecode generated based on a current time at a timing when a state in which the first timecode and the second timecode match is changed to a state in which the first timecode and the second timecode do not match, and set the first timecode to the counter.

9. The image capturing apparatus according to claim 1, wherein the one or more processors further operate to generate the first timecode based on a current time.

10. The image capturing apparatus according to claim 1, wherein the counter counts the second timecode based on the set first timecode.

11. A processing method for an image capturing apparatus comprising:
acquiring a first timecode generated based on a current time and setting the first timecode to a counter;
for a predetermined time period or a predetermined number of times, acquiring the first timecode which has been generated based on a current time, acquiring a second timecode counted by the counter based on the set first timecode, and repeatedly comparing the first timecode and the second timecode;
acquiring, according to a result of the comparing, the first timecode generated based on a current time, and setting the first timecode to the counter; and
adding the second timecode counted by the counter to each frame of a captured image.

12. A non-transitory storage medium storing a program causing an image capturing apparatus to execute a processing method, the processing method comprising:
acquiring a first timecode generated based on a current time and setting the first timecode to a counter;
for a predetermined time period or a predetermined number of times, acquiring the first timecode which has been generated based on a current time, acquiring a second timecode counted by the counter based on the set first timecode, and repeatedly comparing the first timecode and the second timecode;
acquiring, according to a result of the comparing, the first timecode generated based on a current time, and setting the first timecode to the counter; and
adding the second timecode counted by the counter to each frame of a captured image.
